(19) United States
(12) Patent Application Publication
(10) Pub. No.: US 2025/0004566 A1
(43) Pub. Date: Jan. 2, 2025

(54) MACHINE LEARNING BASED GESTURE DETECTION

(71) Applicant: Apple Inc., Cupertino, CA (US)

(72) Inventors: Charles MAALOUF, Seattle, WA (US); Kaan E. DOGRUSOZ, San Francisco, CA (US); Giovanni M. AGNOLI, San Mateo, CA (US); Louis W. BOKMA, Eagle, ID (US); Adam J. LEONARD, San Francisco, CA (US); Behrooz SHAHSAVARI, Los Altos Hills, CA (US); Yiqiang NIE, San Francisco, CA (US); Hojjat Seyed MOUSAVI, San Jose, CA (US); Heriberto NIETO, Seattle, WA (US); Christopher M. SANDINO, Belmont, CA (US)

(21) Appl. No.: 18/751,182

(22) Filed: Jun. 21, 2024

Related U.S. Application Data
(60) Provisional application No. 63/524,618, filed on Jun. 30, 2023.

(51) Int. Cl. G06F 3/01; G06N 20/20

(52) U.S. Cl. CPC G06F 3/017; G06N 20/20

(57) ABSTRACT

Aspects of the subject technology provide improved gesture detection including collection of data from multiple sensors into a data structure that may be analyzed to estimate a plurality of gesture inferences, and then the plurality of gesture inferences may be integrated into a detected gesture for the period of time. Analysis of the data package may be performed by separate machine learning models, each model producing a corresponding gesture inference.

### CROSS REFERENCED TO RELATED APPLICATION(S)

This present application claims the benefit of priority to U.S. Provisional Patent Application No. 63/524,618, entitled “MACHINE LEARNING BASED GESTURE DETECTION,” filed Jun. 30, 2023, the entirety of which is incorporated herein by reference.

### TECHNICAL FIELD

The present description relates generally to human-computer interaction systems, including systems for detecting gestures of a user.

### BACKGROUND

A variety of sensors may be used to detect a user's input to a computer. For example, an inertial measurement unit (IMU) may be attached to a body part of user, such as a wrist, and may be used to detect motion of the body part as input to computer user interface. When a motion of one or more body parts matches a predefined gesture, the gesture may be detected as an input to a computer system.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example environment in which gesture recognition may be implemented.

FIG. 2 illustrates an example system for gesture recognition.

FIG. 3 illustrates an example process for detecting a gesture.

FIG. 4 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Techniques for improved gesture detection include measuring, with multiple sensors, aspects of a user that are indicative of a gesture performed by a user's body part(s) and collecting data over a period of time from the multiple sensors into a muti-sensor data package. The data package may be analyzed to estimate a plurality of gesture inferences, and then the plurality of gesture inferences may be integrated into a detected gesture for the period of time. In an aspect of some implementations, data from the individual sensors may be separately filtered, such as to reduce noise and improve measurement quality, before being collected into the combined data package. The analysis of the data package may be performed by separate machine learning models, each model producing a corresponding gesture inference. Gesture inferences may be combined to detect a gesture inference. For example, gesture inferences may include corresponding confidence ratings, and the gesture inferences may be based on the confidence ratings of the gesture inferences. These techniques may provide improved computational efficiency and gesture detection accuracy, by, for example, collecting a single data package from multiple sensors for a period of time, and then processing the single data package with multiple machine learning models to produce the plurality of gesture inferences.

A gesture inference may correspond to exactly one possible gesture from a predetermined set of gestures that may be detected. Alternately, a gesture inference may indicate only one aspect of one or more possible gestures. For example, a gesture inference may indicate a motion of a body part that is one subset element of a completed gesture. If a user gesture may be defined as a sequence or pattern of movements of one or more of the user's body parts, a gesture inference may indicate one of the movements in the sequence or pattern. For example, a pinch-and-hold gesture and double-pinch gesture may both include moving a finger toward a thumb. A pinch-and-hold gesture may include a first phase where finger 106 and thumb 108 move toward each other, followed by a second phase where finger 106 and thumb 108 may touch each other for a period of time after the first phase. A double-pinch gesture may include a first phase of finger and thumb moving toward each other, second phase where finger and thumb move away from each other, and third phase where they move toward each other again. In an example implementation a pinching gesture inference may indicate simply if a finger and thumb are currently moving toward each other, and such pinch gesture inference may be useful in detecting both the pinch-and-hold gesture and the double-pinch gesture.

FIG. 1 illustrates an example environment 100 in which gesture recognition may be implemented. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

System 100 includes a sensor device 102 attached by strap 112 to a wrist 110 of a user's hand 104, and the user's hand includes a finger 106 and thumb 108. In operation, sensor device 102 may include one or more sensors configured for measuring aspects of the user that are indicative of various movements of the user's hand. For example, sensor device 102 may include an inertial measurement unit (IMU) for measuring movement of the sensor device 102 itself, which may be indicative of movement of the hand 104. An IMU may provide, for example, measurements of translation and/or rotation of hand 104 and wrist 110. Sensor device 102 may include one or more electrodes configured as an electromyography (EMG) sensor. An EMG sensor may provide, for example, measurements of electrical signals in nerves that control skeletal muscles in the hand 104, including skeletal muscles for finger 106 and thumb 108. An EMG sensor may provide an indication of degree of force applied by a skeletal muscle to a bone attached to it, and hence the EMG sensor data may suggest a direction, force, and/or speed of movement of a body part, such movement of hand 104 relative to wrist 110, or movement of finger 106 or thumb 108.

In an aspect, a collection of a plurality of sensors, such as an IMU, EMG and PPG, may all be housed in the single sensor device 102. Integration of such multiple non-invasive sensors in a single device mounted or attached to a user's body part may provide a variety of data that may be integrated for improved gesture detection in a single device that is convenient to wear and use. However, embodiments of the current disclosure are not so limited. In other aspects, multiple sensors for a user's hand or other body part may be positioned in separate devices that each measure aspects of the same body part, and/or aspects that may be indicative of motion of the body part. For example, an IMU or EMG sensor may be included in car in headphones or earbuds worn by the user, and a camera worn on a head or another body part of the user may sense images of the hand 104 of the user.

As depicted in FIG. 1, sensor device 102 is attached at the wrist 110 of hand 104 for sensing hand 104, finger 106 and/or thumb 108. However, embodiments of the current disclosure are not so limited. In other aspects, sensor device 102 may be attached to another part of the user's arm, such as elsewhere on the forearm or upper arm of hand 104, and sensor device 102 may detect motion of other parts of hand 104, such as the other fingers not labeled in FIG. 1. Additionally, as depicted in FIG. 1, sensor device is attached to wrist 110 with strap 112. Other implementations may not use a strap and may use other means for positioning or attaching a sensor device relative to a body part.

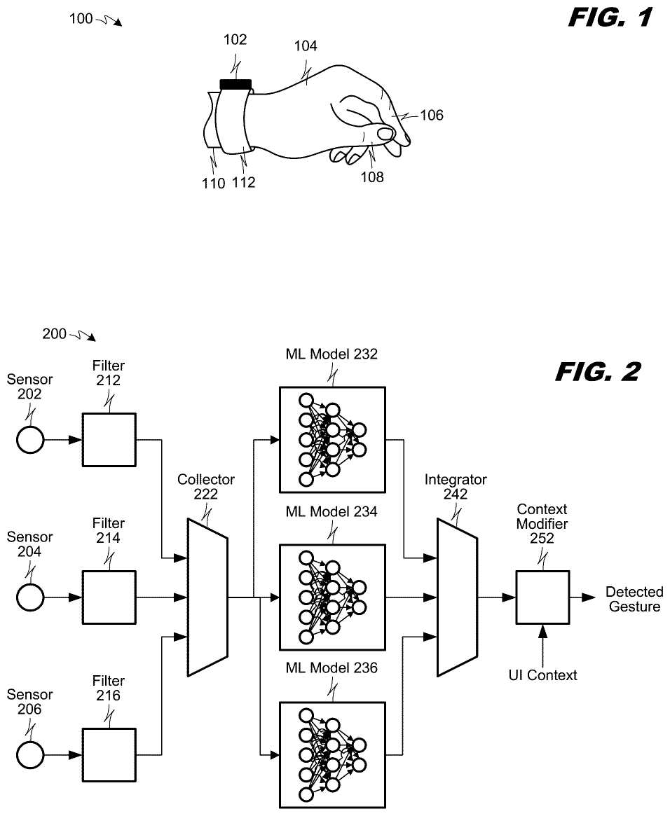

FIG. 2 illustrates an example system 200 for gesture recognition. System 200 may be implemented, for example, in sensor device 102 (FIG. 1). System 200 includes sensors 202, 204, 206, filters 212, 214, 216, sensor data collector 222, ML models 232 234, 236, gesture inference integrator 242, and a context modifier 252. In operation, sensors 202, 204, 206 may measure distinct aspects of a user, such as different aspects of the same body part of the user. The sensor data generated by individual sensors may be filtered by a corresponding filter 212, 214, 216. Collector 222 may collect the filtered sensor data over a period time from all sensors into a single data package for that period of time, and the single data package may be separately analyzed by ML models 232, 234, and 236, which may each produce a corresponding gesture inference. Integrator 242 may integrate the gesture inferences to produce an initial detected gesture. Context modifier 252 may modify the initial detected gesture based on a current context of system 200, such a context of a UI system to produce a modified detected gesture.

Sensors 202, 204, 206 may measure different body parts of a user, or may measure distinct aspects of the same body part of the user. For example, sensors 202, 204, and 206 may include an IMU, EMG, and/or ECG sensors at a user's wrist, as in sensor device 102 (FIG. 1). As depicted in FIG. 2, system 200 includes three sensors 202, 204, 206, but the techniques of this disclosure may also find application in systems with any number of sensors.

Filters 212, 214, 216 may improve the quality or reliability of the corresponding sensor measurements. For example, filters 212, 214, 216 may include a noise reducing filter tailored to the individual sensor measurements, such as a lowpass or bandpass filter or another linear filter. Alternately or in addition, filters 212, 214, 216 may mute or otherwise drop measurement samples when the corresponding sensor's output is determined to be unreliable. For example, when Bluetooth™ or other electronics in a sensor device interfere with one (or more) of the sensor measurements, sensor measurements taken during use of the interfering electronics may dropped and not included in a sensor data package produced at collector 222.

Collector 222 may collect filtered sensor data from the sensors corresponding to a period of time into a sensor data package. A data package may be a data structure that includes data collected over a period of time. The period of time for the data structure may be, for example 1/32^{nd} of a second, and may be shorter than the time required for a user to perform a gesture, which may be, for example, 150 milliseconds. The amount of data collected into a data package may vary between sensors, for example due to the sensors operating at different sensor sampling frequencies, filtering/discarding of unreliable or poor-quality sensor samples, or due to different periods of sampling time for which data is available between the sensors. A data package may be implemented in a variety of techniques that allow all ML models 232, 234, 236 to process the same data in the data package. For example, a pointer to a single read-only storage buffer containing data from all sensor data may be provided to each ML model, each ML model may be provided a separate copy of the storage buffer with all sensor data, or the data package may be implemented as a list of memory references, each reference pointing to separate buffers for each of the sensors where the separate buffers include sensor data corresponding to the period of time of the sensor package.

Machine learning models 232,234, 236 may be trained to infer gesture inferences. Each of the machine learning models 232,234, 236 may be trained on packages of sensor data to infer a likelihood or confidence of a different corresponding gesture inference for the time period corresponding to an input sensor data package. For example, a first machine learning model may be trained to infer a corresponding first gesture inference such as a pinching gesture inference, while a second machine learning model may be trained to infer a second gesture inference such as a releasing gesture inference. In an aspect, identical sensor data packages are provided to each of the machine learning models 232, 234, 236, such that each gesture inference produced by the separate corresponding ML models 232, 234, 236 may be based on the same sensor data and correspond to the time period of the input data package, even when the ML models do not operate exactly simultaneously. In some implementations one or more of the ML models may include a memory such that a gesture inference produced by a ML model in response to a currently input data package may also be dependent on previous data packages.

Examples of gesture inferences produced by analysis of a sensor data package may include static gesture states inferences as well as motion transition gesture states inferences. For example, a pinch-closed-state machine learning model may produce a static-closed gesture inference indicating a thumb and forefinger are touching and not moving relative to each other. A pinch-transition machine learning model may produce a pinching-motion transition gesture inference indicating a thumb and finger are moving toward each other. A release-transition machine learning model may produce a releasing-motion transition gesture inference may indicate a thumb and finger are moving away from each other.

In some aspects, machine learning models 232, 234, 236 may each produce one gesture inference for a every sensor data package input to the machine learning models. However, implementations are not so limited. For example, one or more of the machine learning models may produce a plurality of gesture inferences from a single sensor data package. In another example, one or more of the machine learning models may require a plurality of sensor data packages to produce a single gesture inference,

As depicted in FIG. 2, analysis of collected sensor data packages is performed by three machine learning models 232, 234, 236. However, implementations are not so limited. In one aspect, analysis to produce a gesture inference need not be performed by a machine learning model, and instead may be performed by other types of analysis or logic. In another aspect, the number of machine learning models is not limited to three, and the number need not correspond to the number of sensors. For example, data from two sensors may be collected and analyzed to produce five gesture inferences, or data from four sensors may collected and analyzed to produce six gesture inferences.

Integrator 242 may integrate the gesture inferences produced by the ML models 232, 234, 236 to determine an initial detected gesture. In an aspect, the ML models may produce a time-ordered sequence of gesture inferences in response to a sequence of collected sensor data packages, and the ML models may produce gesture inferences more frequently than a user may perform a complete gesture, such that a plurality of gesture inferences over time may be generated over the time a user is performing a gesture. The integrator 242 may integrate a multiple gesture inferences from a single ML model as well as integrating gestures inferences from multiple ML models into a one detected gesture. For example, gesture inferences may be produced at a rate corresponding to the period of time collected into a sensor data structure, such as 1/32^{nd} of a second, and integrator 242 may detect a gesture that occurs over, for example 150 milliseconds. In an aspect, gesture detector 242 may detect gestures at a slower frequency than gesture inferences are produced by the ML models 232, 234, 236.

In another aspect, integrator 242 may detect patterns of gesture inferences. A pattern of gesture inferences may correspond to a detected gesture. For example, following on the gesture inference examples above, a time sequence pattern of a pinch-closing gesture inference followed by a static-closed gesture inference may be integrated over time to detect a pinch-closed gesture. In another example, integrator 242 may detect a double-pinch gesture when it receives a time sequence pattern of gesture inferences including pinch-closing, followed by releasing, and finally pinch-closing again. In an aspect, integrator 242 may distinguish between a plurality of possible predetermined gestures. For example, integrator 242 may distinguish between a pinch-closed gesture and a double-pinch gesture.

In an aspect, instead of producing a single detected gesture, integrator 242 may produce a likelihood score for each of a plurality different gestures that a user may be performing at a particular time. A subsequent component, such as context modifier 242, may select a final detected gesture based on the likelihood scores.

In an aspect not depicted in FIG. 2, each type of gesture inferences may be produced by a cascade of two sequential machine learning models. For example, for one type of gesture inference, such as static-closed gesture, a first machine learning model may consume sensor data packages from collector 222 to produce interim gesture inferences for the static-closed. For example, the first machine learning model may produce exactly one interim gesture inference for each sensor data package it consumes. Then a second machine learning model may consume the interim gesture inferences to produce a final static closed gesture inference. In an aspect, a static-closed gesture may be defined as fingers touching for a threshold amount of time, and the second machine learning model may include the time memory of interim gesture inferences that may be used to measure the time threshold.

Context modifier 252 may modify an initial detected gesture based on a current context for user input. When a user's gesture input is used as input to a computer user interface, a current context for the user interface may indicate that only a subset of user gestures is currently available in the current context. For example, some application on a computer may use a double-pinch gesture, while a double pinch-gesture may have no meaning in other applications. When a current user interface context has no meaning for a double-pinch gesture, context modifier 252 may modify a detected double-pinch gesture to instead select a second most likely user gesture as the modified detected gesture for output to the user interface. For example, context modifier 252 may receive an indication, such as from an operating system or software application providing a user interface, that the user interface currently does not accept a certain gesture (or if the certain gesture does not currently have any meaning assigned to it) then context modifier 252 may select a second most likely user gesture as the modified detected gesture when the most likely gesture corresponds to is indicated as not currently accepted by the user interface.

In an example application of system 200 to a computer user interface, the computer interface may present a list of options to a user including a currently selected item in the list. The user may perform a pinch gesture to indicate that a selection should move to the next item in the list, while a double-pinch gesture may indicate that the selection should move to the previous item in the list. When the user interface is presenting a list with the first item in the list selected, the context of the user interface may indicate that double-pinch is not currently available because there is no item prior to filter item in the list. In this situation, if integrator 242 indicates double pinch is the most likely gesture while pinch gesture is the second most likely gesture, context modifier 242 may eliminate the double-pinch gesture as candidate causing the pinch gesture to be selected as the final detected gesture.

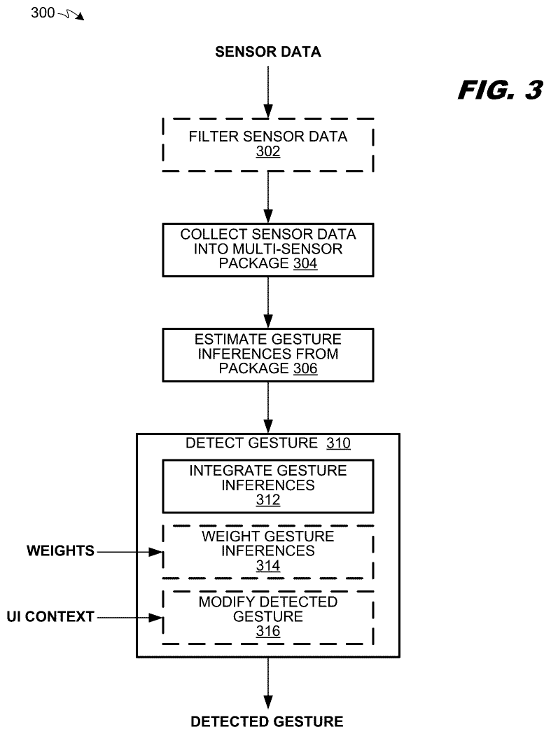

FIG. 3 illustrates an example process 300 for detecting a gesture. Process 300 may be implemented, for example, on system 200 (FIG. 2) or sensor device 102 (FIG. 1.) Process 300 includes collecting, such as by collector 222, data from a plurality of sensors into a sensor data package (304). Aspects of a predetermined set of possible user gestures may be estimated as a plurality of gesture inferences from the sensor data package (306), such as by machine learning models 232, 234, 236. A gesture may be detected (310) including integrating the plurality of gesture inferences (312) to produce an initial detected gesture.

In some optional aspects of process 300, sensor data may be filtered (302), such as by filters 212, 214, 216, prior to collecting sensor data into a package (304). Detecting a gesture (310) may further include weighting the gesture inferences (314) such that some gesture inferences have stronger influence over the resulting detected gesture than other gesture inferences. For example, if some gesture inferences are more reliably correct, they may have a higher weight (and stronger influence) in a resulting detected gesture as compared to other gesture inferences that are less reliably correct. An initial detected gesture may be modify (316) based on a context of a consumer of the detected gestures, such as a current context of a computer user interface.

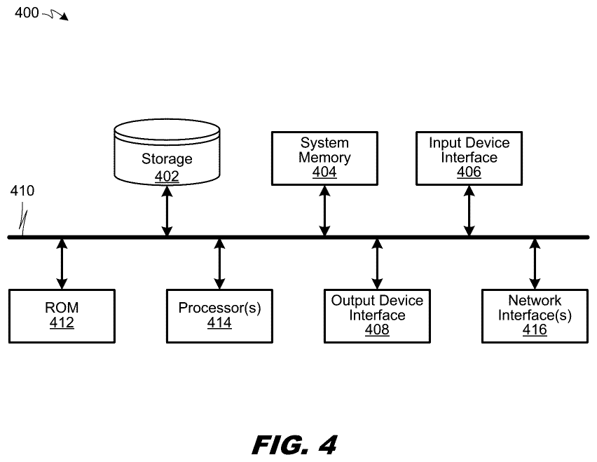

FIG. 4 illustrates an example computing device 400 with which aspects of the subject technology may be implemented in accordance with one or more implementations, including, for example system 200 (FIG. 2) and process 300 (FIG. 3). The computing device 400 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 400 may include various types of computer readable media and interfaces for various other types of computer readable media. The computing device 400 includes a permanent storage device 402, a system memory 404 (and/or buffer), an input device interface 406, an output device interface 408, a bus 410, a ROM 412, one or more processing unit(s) 414, one or more network interface(s) 416, and/or subsets and variations thereof.

The bus 410 collectively represents all system, peripheral, and chipset buses that communicatively connect the numerous internal devices of the computing device 400. In one or more implementations, the bus 410 communicatively connects the one or more processing unit(s) 414 with the ROM 412, the system memory 404, and the permanent storage device 402. From these various memory units, the one or more processing unit(s) 414 retrieves instructions to execute and data to process in order to execute the processes of the subject disclosure. The one or more processing unit(s) 414 can be a single processor or a multi-core processor in different implementations.

The ROM 412 stores static data and instructions that are needed by the one or more processing unit(s) 414 and other modules of the computing device 400. The permanent storage device 402, on the other hand, may be a read-and-write memory device. The permanent storage device 402 may be a non-volatile memory unit that stores instructions and data even when the computing device 400 is off. In one or more implementations, a mass-storage device (such as a magnetic or optical disk and its corresponding disk drive) may be used as the permanent storage device 402.

In one or more implementations, a removable storage device (such as a floppy disk, flash drive, and its corresponding disk drive) may be used as the permanent storage device 402. Like the permanent storage device 402, the system memory 404 may be a read-and-write memory device. However, unlike the permanent storage device 402, the system memory 404 may be a volatile read-and-write memory, such as random-access memory. The system memory 404 may store any of the instructions and data that one or more processing unit(s) 414 may need at runtime. In one or more implementations, the processes of the subject disclosure are stored in the system memory 404, the permanent storage device 402, and/or the ROM 412. From these various memory units, the one or more processing unit(s) 414 retrieves instructions to execute and data to process in order to execute the processes of one or more implementations.

The bus 410 also connects to the input and output device interfaces 406 and 408. The input device interface 406 enables a user to communicate information and select commands to the computing device 400. Input devices that may be used with the input device interface 406 may include, for example, alphanumeric keyboards and pointing devices (also called “cursor control devices”). The output device interface 408 may enable, for example, the display of images generated by computing device 400. Output devices that may be used with the output device interface 408 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 4, the bus 410 also couples the computing device 400 to one or more networks and/or to one or more network nodes through the one or more network interface(s) 416. In this manner, the computing device 400 can be a part of a network of computers (such as a LAN, a wide area network (“WAN”), or an Intranet, or a network of networks, such as the Internet. Any or all components of the computing device 400 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.ssz

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
processing a sensor data structure by each respective machine learning model of a plurality of machine learning models to produce a corresponding respective gesture inference of a plurality of gesture inferences, wherein each respective machine learning model is trained to infer a corresponding aspect of a gesture by the body part, and each gesture inference relates to its corresponding aspect of a gesture, and wherein the sensor data structure includes sensor data from a plurality of sensors over a period of time and each of the plurality of sensors generates data indicative of at least one aspect of a body part of a user;
determining a detected gesture of the body part corresponding to the collected sensor data based at least in part on the plurality of gesture inferences; and
performing an action based on the detected gesture.

2. The method of claim 1, further comprising collecting the sensor data from the plurality of sensors over the period of time into the sensor data structure.

3. The method of claim 1, wherein the plurality of machine learning models includes:
a pinch-closed-state model producing a static-closed gesture inference,
a pinch-transition model producing a pinching-motion inference, and
a release-transition model producing a releasing-motion inference.

4. The method of claim 1, wherein the detected gesture is selected from a list comprising: a pinch-closed gesture, a pinch-closing gesture, a pinch-releasing gesture, and a double-pinch gesture.

5. The method of claim 1, further comprising modifying the detected gesture based on a current context of a user interface.

6. The method of claim 1, wherein at least one of the plurality of gesture inferences corresponds to an aspect of a gesture occurring during a current period of time and is based on the collected sensor data for the current period of time and a prior period of time before the current period of time.

7. The method of claim 1, wherein the detected gesture is based on a weighting amongst the plurality of gesture inferences, and the weighting for a current time period is based on the gesture inferences for a prior time period before the current time period.

8. The method of claim 1, wherein the action includes providing the detected gesture to a user interface having a context and an input based on the detected gesture.

9. A device, comprising:
a processor; and
a computer memory storing instructions that, when executed by the processor, cause the device to:
collect sensor data from a plurality of sensors over a period of time into a sensor data structure, wherein each of the plurality of sensors generates data indicative of at least one aspect of a body part of a user;
process the sensor data structure by each respective machine learning model of a plurality of machine learning models to produce a corresponding respective gesture inference of a plurality of gesture inferences, wherein each respective machine learning model is trained to infer a corresponding aspect of a gesture by the body part, and each gesture inference relates to its corresponding aspect of a gesture;
determine a detected gesture of the body part corresponding to the collected sensor data based at least in part on the plurality of gesture inferences; and
perform an action based on the detected gesture.

10. The device of claim 9, further comprising:
the plurality of sensors; and
a user interface having a context and an input based on the detected gesture.

11. The device of claim 9, wherein the plurality of machine learning models includes
a pinch-closed-state model producing a pinch-hold gesture inference,
a pinch-transition model producing a pinching motion inference, and
a release-transition model producing a releasing motion inference.

12. The device of claim 9, wherein the detected gesture is selected from a list comprising: a pinch-closed gesture, a pinch-closing gesture, a pinch-releasing gesture, and a double-pinch gesture.

13. The device of claim 9, wherein the instructions further cause the device to:
modify the detected gesture based on a current context of a user interface.

14. The device of claim 9, wherein at least one of the plurality of gesture inferences corresponds to an aspect of a gesture occurring during a current period of time and is based on the collected sensor data for the current period of time and a prior period of time before the current period of time.

15. The device of claim 9, wherein the detected gesture is based on a weighting amongst the plurality of gesture inferences, and the weighting for a current time period is based on the gesture inferences for a prior time period before the current time period.

16. A computer storage device storing instructions that, when executed on a processor, cause the processor to:
collect sensor data from a plurality of sensors over a period of time into a sensor data structure, wherein each of the plurality of sensors generates data indicative of at least one aspect of a body part of a user;
process the sensor data structure by each respective machine learning model of a plurality of machine learning models to produce a corresponding respective gesture inference of a plurality of gesture inferences, wherein each respective machine learning model is trained to infer a corresponding aspect of a gesture by the body part, and each gesture inference relates to its corresponding aspect of a gesture;
determine a detected gesture of the body part corresponding to the collected sensor data based at least in part on the plurality of gesture inferences; and
perform an action based on the detected gesture.

17. The storage device of claim 16, wherein the plurality of machine learning models includes
a pinch-closed-state model producing a pinch-hold gesture inference,
a pinch-transition model producing a pinching motion inference, and
a release-transition model producing a releasing motion inference.

18. The storage device of claim 16, wherein the detected gesture is selected from a list comprising: a pinch-closed gesture, a pinch-closing gesture, a pinch-releasing gesture, and a double-pinch gesture.

19. The storage device of claim 16, wherein the instructions further cause the processor to:
modify the detected gesture based on a current context of a user interface.

20. The storage device of claim 16, wherein at least one of the plurality of gesture inferences corresponds to an aspect of a gesture occurring during a current period of time and is based on the collected sensor data for the current period of time and a prior period of time before the current period of time.
